(19) United States
(12) Patent Application Publication
(10) Pub. No.: US 2026/0278175 A1
(43) Pub. Date: Sep. 17, 2026

(54) MULTI-AGENT COLLABORATIVE INFORMATION PROCESSING SYSTEM WITH INHERITABLE STATE RECONSTRUCTION AND CONDITIONAL AUTHORITY REALLOCATION

(71) Applicant: Koji Mochizuki, Suita (JP)

(72) Inventor: Koji Mochizuki, Suita (JP)

(21) Appl. No.: 19/651,723

(22) Filed: Apr. 19, 2026

(30) Foreign Application Priority Data
Apr. 19, 2026 (JP) 2026-069114

(51) Int. Cl. G06F 21/64; H04L 9/32

(52) U.S. Cl. CPC G06F 21/64; H04L 9/3213; H04L 9/3236; H04L 9/3247

(57) ABSTRACT

A collaborative decision-processing system and method are disclosed. Candidate-task data, evidence-reference data, an approval-state record, an authority-state record, and an identifier of a current subject are received for a decision task handled by multiple subjects. When the task is deferred, an inheritable state package is generated and stored with a task identifier, a process-stage identifier, unresolved items, evidence-reference pointers, an approval-state bit field, an authority-token set, at least one resume condition, and a checkpoint or re-execution reference. A degradation score for the current subject is computed from at least two metrics selected from availability, response latency, error rate, backlog, confidence score, and audit-pass rate. When a transfer criterion is satisfied, an authority-mapping table is updated to transfer less than all authorities to a distinct successor subject. Integrity of preserved intermediate results is verified, and only unresolved subtasks are resumed while verified intermediate results are preserved.

### CROSS-REFERENCE TO RELATED APPLICATIONS

This application claims priority under 35 U.S.C. 119(a) to Japanese Patent Application No. 2026-069114, filed on Apr. 19, 2026, the entire contents of which are incorporated herein by reference.

### TECHNICAL FIELD

The present disclosure relates to information processing for collaborative decision making by a plurality of agents. More particularly, the present disclosure relates to a system and method for storing an intermediate decision state as an inheritable state package, conditionally reallocating at least a subset of authority when a responsible agent degrades, and enabling a successor agent to reconstruct or resume processing from an intermediate stage.

### Definitions

As used herein, “agent” refers to an element capable of performing at least part of decision making, evaluation, approval, reconstruction, control, or information processing. An agent may include a human, an information processing device, a software function, an external system connected through a communication network, an external judgment function, or a combination thereof.

As used herein, “candidate process” refers to a process unit that is subject to at least one decision concerning execution, approval, modification, reevaluation, deferment, or stopping. A candidate process may be represented as an instruction sequence, a design-change request, an analysis request, a verification job, a release request, a retraining request, an experiment plan, or a data structure corresponding thereto.

As used herein, “inheritable state package” refers to a machine-readable data set representing an intermediate state of a candidate process in a form that can be referenced by a successor agent distinct from a subject agent. The inheritable state package may include at least an identifier of the candidate process, a process stage, unresolved items, evidence references, approval state, authority state, one or more reevaluation conditions, one or more resume conditions, and processing history.

As used herein, “successor agent” refers to an agent that, after authority transfer, inherits and reconstructs or resumes at least part of a candidate process previously assigned to a subject agent.

As used herein, “confidence score” refers to a score derived from decision quality, response quality, past correctness, audit result, restart success, rule conformity, or a combination thereof.

As used herein, “checkpoint reference” refers to reference information indicating an intermediate restart point that corresponds to accepted intermediate results, computation state, data location, or an unresolved-item set. A “re-execution reference” refers to reference information for re-executing from a specified intermediate stage or subtask rather than from an initial state.

### BACKGROUND

Collaborative processing among human agents, artificial-intelligence agents, and external systems has become common in release review, engineering analysis, design automation, and research workflows. In such environments, one agent may generate or evaluate a candidate process while another agent reviews evidence, approval states, or authority states.

In practice, however, a responsible agent may become unsuitable for continued processing due to departure, unavailability, communication delay, increased error rate, queue stagnation, exhausted computational resources, service interruption, or reduced confidence. As a result, reasons for deferment, unresolved items, approval statuses, authority statuses, and evidence relationships may not remain sufficiently coupled. This can make it difficult for a successor agent to accurately reconstruct an intermediate state, and can cause delay, duplicated review, incorrect judgment, and blurred responsibility boundaries.

Existing techniques for deferment or exploratory processing generally focus on allowing a current agent to continue or defer a decision, rather than on providing a machine-readable inheritable state package for a successor agent. Existing role-based authority control techniques generally focus on release-state control or role assignment, rather than on conditional authority reallocation triggered by degradation of a subject agent and followed by successor-side reconstruction or resume. Existing restoration techniques generally focus on restoring a state itself, rather than on integrated control of inheritance, approval state, authority reallocation, and successor restart in a multi-agent environment.

Accordingly, a need exists for a technical framework that improves continuity, inheritability, and successor-side restartability in multi-agent collaborative processing while reducing reliance on a degraded agent and conditionally transferring authority to a more appropriate successor agent.

### SUMMARY

In one aspect, a collaborative information processing system receives candidate-process information, evidence-reference information, authority-state information, approval-state information, and subject-agent identification information; determines whether a candidate process is to be finalized, deferred, or designated for reevaluation; generates and stores an inheritable state package when the candidate process is deferred; computes a degradation score for a subject agent; conditionally reallocates at least a subset of authority to a successor agent distinct from the subject agent by updating a machine-readable authority mapping table and redirecting routing destinations; verifies package integrity; preserves accepted intermediate results; identifies unresolved subtasks; and causes the successor agent to reconstruct or resume the candidate process from an intermediate stage.

In another aspect, the system may further provide arbitration among multiple decision tracks, update one or more thresholds or evaluation functions, resolve conflict among multiple approval gates, and manage multiple operational regimes.

The disclosed subject matter therefore provides a practical implementation for inherited intermediate-state handling, conditional authority reallocation, and successor-side restart in a form that improves continuity, reproducibility, and auditability.

### BRIEF DESCRIPTION OF THE DRAWINGS

FIG. 1 shows an example overall configuration of a collaborative information processing system.

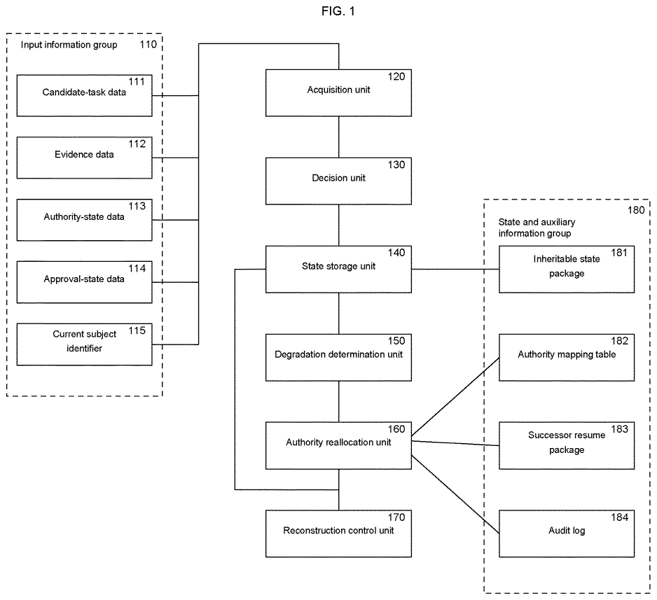

FIG. 2 shows an example state transition of a candidate process.

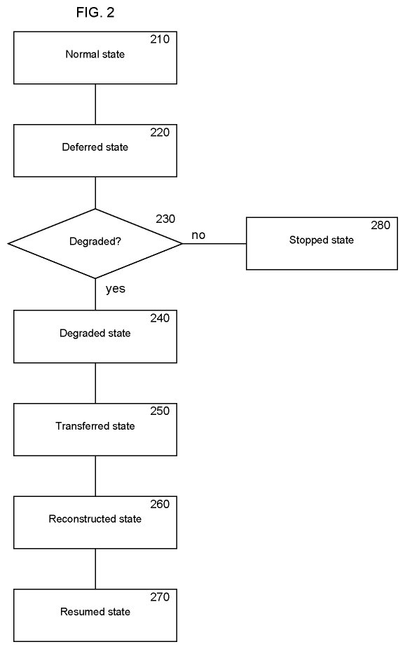

FIG. 3 shows an example data structure of an inheritable state package.

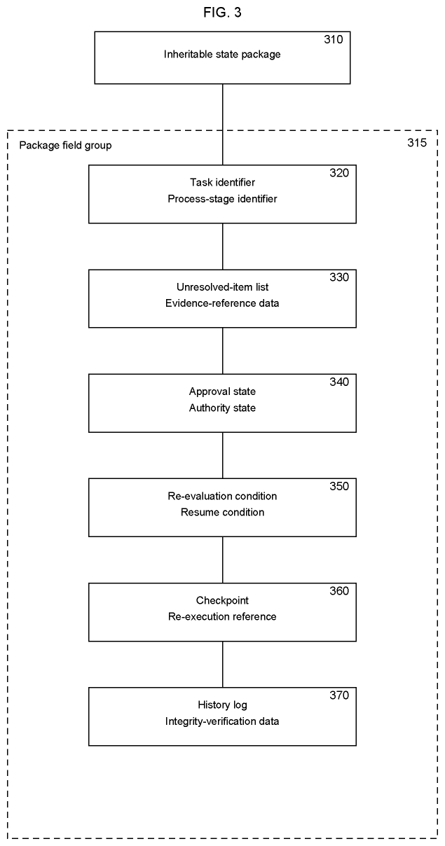

FIG. 4 shows an example update flow for an authority mapping table and routing destination change.

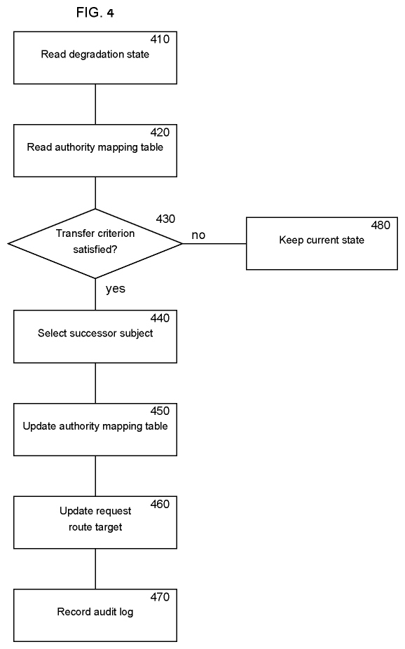

FIG. 5 shows an example reconstruction and resume flow performed by a successor agent.

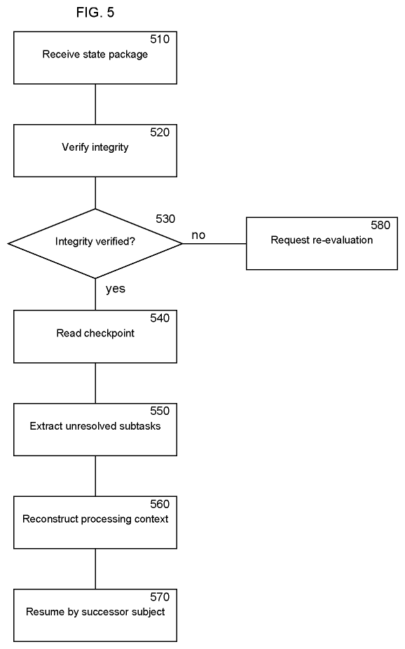

FIG. 6 shows an example arbitration flow among multiple decision tracks.

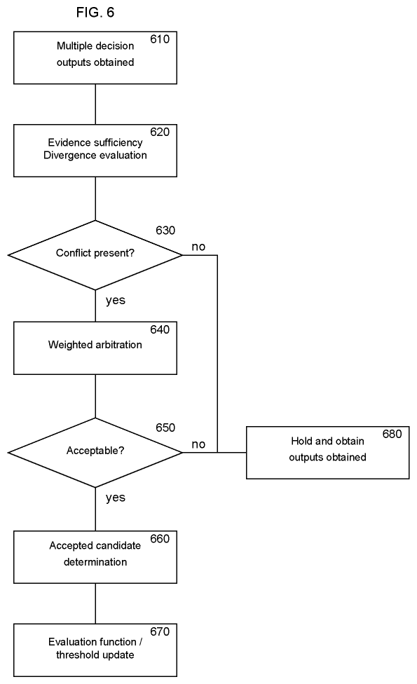

FIG. 7 shows an example application involving collaboration between a human agent and an artificial-intelligence agent.

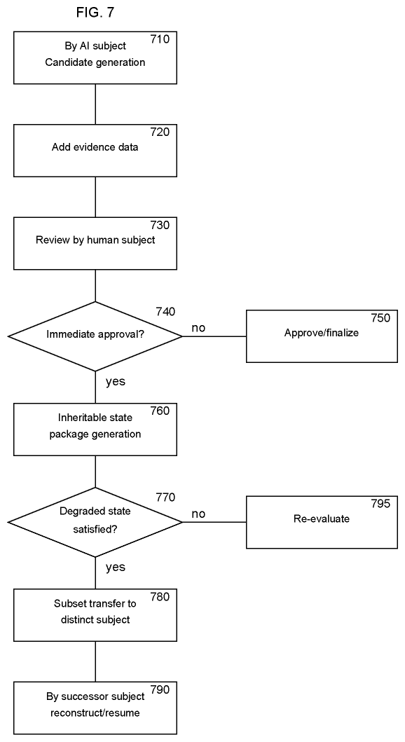

FIG. 8 shows an example application involving collaboration among multiple artificial-intelligence agents or information processing systems.

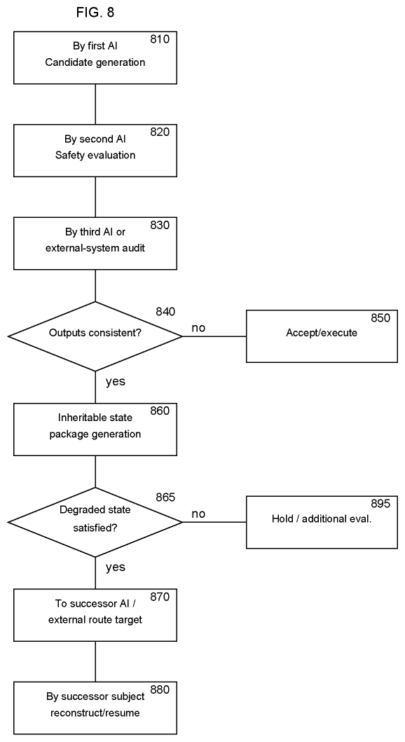

FIG. 9 shows an example in which a candidate process is classified into one of release review, electronic design automation, and research workflow and then connected to common state-retention, authority-reallocation, and restart processing.

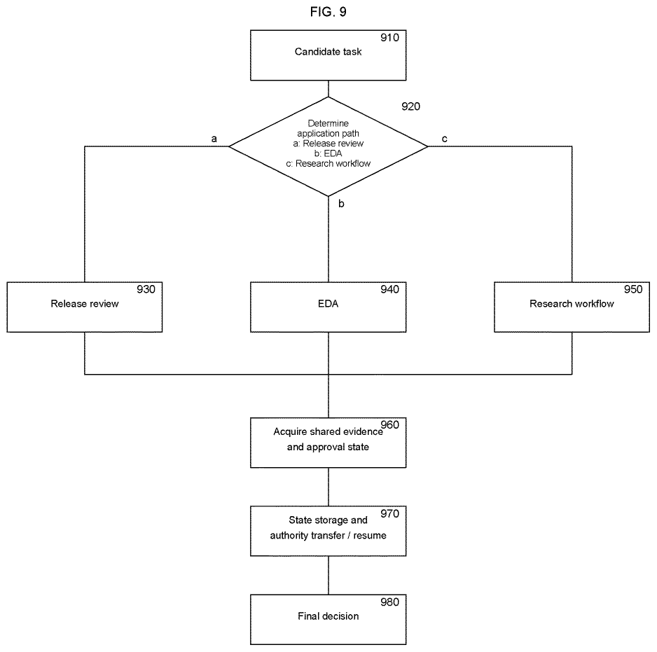

### DETAILED DESCRIPTION

A system according to the present disclosure may include one or more processors, one or more memories, one or more storage devices, a communication interface, and, where appropriate, input/output devices. The memory may store instructions that implement candidate-process management, state-package generation, degradation determination, authority reallocation, restart-package generation, successor selection, arbitration, threshold updating, approval-conflict adjustment, state management, and audit-log management.

Candidate-process management may receive candidate-process information, evidence-reference information, authority-state information, approval-state information, and subject-agent identification information. Candidate-process information may include a candidate-process identifier, a process type, a request source, one or more target data sets, a priority, a deadline, and one or more related job identifiers.

Evidence-reference information may include log references, verification reports, simulation results, model outputs, test results, review comments, audit records, document pointers, and results acquired from an external system. Such evidence may be stored or referenced by a file path, URL, hash value, database key, object identifier, or equivalent reference structure.

Authority-state information may indicate which agent possesses which authority type. Examples include approval authority, reevaluation-request authority, candidate-modification authority, execution-permission authority, stop authority, and audit-request authority. Approval-state information may include, for example, not-approved, first-stage approved, waiting for multiple approvals, remanded, deferred, in conflict, stopped, or restart-approved.

A decision engine may determine whether a candidate process should be finalized, deferred, or designated for reevaluation. In one implementation, deferment or reevaluation is selected when an evidence-sufficiency score is below a threshold, when multiple decision tracks differ beyond a threshold, or when one or more approval gates remain unsatisfied.

An evidence-sufficiency score may be computed from a quantity of available evidence items, a freshness metric for the available evidence items, a source-reliability metric, and a consistency metric among the available evidence items. Divergence among outputs of multiple decision engines may be represented as a score derived from a difference between classification labels, a distance between ranked outputs, a variance among confidence values, or a conflict count across approval recommendations.

When a candidate process is deferred, a state-package engine generates an inheritable state package. The inheritable state package may include, by way of example:
(1) a task identifier;
(2) a session identifier or process-sequence identifier;
(3) a process-stage identifier;
(4) a candidate-process type;
(5) a subject-agent identifier;
(6) a candidate-process body or a reference thereto;
(7) an unresolved-item list;
(8) an evidence-reference pointer set;
(9) a reason record;
(10) an approval-state bitmap;
(11) an authority-token set;
(12) one or more reevaluation conditions;
(13) one or more resume conditions;
(14) a checkpoint reference;
(15) a re-execution reference;
(16) an audit-log reference;
(17) a creation time;
(18) an expiration time or invalidation condition;
(19) a version number; and
(20) an integrity-verification value.

The unresolved-item list may include, for example, “additional review pending,” “simulation unfinished,” “external evidence pending,” “threshold condition not satisfied,” or “approver B has not responded.” The reason record may include a reason for deferment or reevaluation, references to evidence used at that time, and one or more rejected alternative candidates.

The approval-state bitmap may encode statuses of multiple approval gates. For example, a first bit position may correspond to a first-stage review, another bit position to a safety review, another bit position to a quality review, and another bit position to an audit review. Each position may represent values such as incomplete, approved, remanded, or deferred.

The authority-token set may indicate valid authority types, target scope, validity period, transferability, re-transferability, and audit attributes for the candidate process.

A degradation-determination engine computes a degradation score for the subject agent. In one example:

$$G = w 1 ( 1 - A ) + w 2 D + w 3 E + w 4 B + w 5 ( 1 - R )$$

where A is availability, D is response delay, E is error rate, B is process stagnation, R is a confidence score, and w1 through w5 are weights. A threshold condition may be met when G is greater than or equal to a threshold T1. In some implementations, the threshold T1 or T2 is stored per task class or per regime for the decision task. A higher threshold T2 may indicate an immediate-transfer candidate.

Availability may be calculated from response success rate or runtime availability over a predetermined period. Response delay may be calculated from mean, median, or percentile latency between request issuance and response receipt. Error rate may be based on incorrect judgments, remands, failed jobs, or correction frequency. Process stagnation may be based on a number of unprocessed tasks, overdue tasks, or average waiting time. A confidence score may be derived from approval consistency, audit pass rate, restart success rate, rule conformity, or a combination thereof.

An authority-reallocation engine conditionally reassigns at least a subset of authority from the subject agent to a successor agent distinct from the subject agent when the degradation criterion is satisfied. In one implementation, the authority-reallocation engine updates a machine-readable authority mapping table and redirects routing destinations for approval requests, reevaluation requests, modification requests, stop requests, or execution requests.

An example authority mapping table may include, for each candidate process:
(1) a candidate-process identifier;
(2) a request type;
(3) a current responsible agent identifier;
(4) one or more successor-candidate identifiers;
(5) a transfer condition;
(6) a priority value;
(7) an effective time;
(8) an invalidation condition;
(9) a current state; and
(10) an audit-log reference.

The transfer condition may include, for example, response delay above a threshold, confidence score below a threshold, no approval response within a predetermined period, or a prolonged unsatisfied approval gate. The authority-mapping table may further store, for each request type, a route target identifying a routing destination after transfer. The invalidation condition may include recovery of the subject agent, remand by an audit agent, or cancellation of reallocation.

The system need not transfer all authority. In some embodiments, only approval authority is transferred while candidate-modification authority remains with the subject agent. In other embodiments, only first-stage approval or reevaluation-request authority is transferred while final approval remains with an audit agent or administrative agent.

In a further implementation, the transferred subset of authority explicitly excludes final-approval authority. In such an implementation, the authority-reallocation engine may transfer first-stage approval authority, reevaluation-request authority, or both, to the successor subject while maintaining final-approval authority with an audit subject or an administrative subject. This arrangement enables continued processing and reevaluation by the successor subject without granting the successor subject authority to issue a final approval.

A successor-selection engine may select a successor agent from multiple candidates based on a successor-selection score. The score may be calculated from at least two of availability, processing capacity, task fit, or past restart success rate, and may be used together with a task-class-specific or regime-specific threshold.

In some implementations, the successor-selection score is computed only among successor candidates that satisfy a regime-dependent eligibility rule. For example, in an audit-enhanced regime, the successor-selection engine may require an audit-pass rate above a first threshold, while in an emergency-transfer regime the successor-selection engine may prioritize availability and processing capacity over task-fit score. The selected successor subject may therefore vary across regimes even for the same decision task.

A restart-package engine may generate a successor restart package distinct from the inheritable state package. The successor restart package may include a successor-agent identifier, a transferred-authority scope, restart-target task information, a permitted operation scope, a restart deadline, an audit condition, and one or more notification destinations.

A reconstruction-and-resume engine verifies integrity of the inheritable state package based on the integrity-verification value. The engine then preserves accepted intermediate results that satisfy an integrity-verification condition or a prior-acceptance condition, identifies unresolved subtasks based on the process-stage identifier, unresolved-item list, and checkpoint or re-execution reference, and causes the successor agent to reconstruct or resume the candidate process from an intermediate stage without restarting the entire processing sequence.

Accepted intermediate results may include, for example, logs that have passed audit, completed simulation results, approved partial decisions, validated intermediate design artifacts, or other intermediate outputs that satisfy a prior-acceptance condition. Some preserved results may be presented to the successor agent with a reconfirmation flag.

The inheritable state package may include an integrity-verification value such as a cryptographic hash or digital signature associated with the package or with preserved intermediate results. If tampering or corruption is detected, or if an expiration time has elapsed or an invalidation condition has been met, the system may block automatic restart and instead request reevaluation or reapproval.

Integrity verification may be performed per preserved intermediate result, per group of preserved intermediate results, or for the inheritable state package as a whole. When a preserved intermediate result fails verification, the reconstruction-and-resume engine may preserve other intermediate results that passed verification, mark only unresolved subtasks associated with the failed result for re-execution, and maintain routing and approval information for the remaining verified portions of the decision task.

An arbitration engine may operate when multiple decision tracks provide different outputs. The arbitration engine may determine an adopted candidate, a deferred candidate, or a reevaluation target based on priority, confidence score, evidence-sufficiency score, past performance, approval state, or weighted combinations thereof. In some implementations, deferment or reevaluation is triggered when the evidence-sufficiency score is below a threshold or when divergence among outputs of multiple decision engines exceeds a threshold.

A threshold-update engine may update one or more thresholds or evaluation functions based on an erroneous-transfer rate, restart-success rate, audit-remand rate, or stagnation-improvement rate.

In some implementations, the authority-mapping table stores, for each request type associated with the decision task, a route target that identifies the subject currently authorized to handle that request type. When the transfer criterion is satisfied, the authority-reallocation engine changes the route target for each transferred request type to the successor subject while retaining, for each non-transferred request type, a route target assigned to the current subject, an audit subject, or an administrative subject. In this manner, less than all authorities are transferred and at least one authority remains outside the transferred subset.

In some implementations, the reconstruction-and-resume engine consults the updated authority-mapping table before resume and enables the successor subject to resume only unresolved subtasks for which the successor subject is identified as the authorized route target. Unresolved subtasks mapped to a non-transferred authority remain blocked from successor-side execution until a corresponding current subject, audit subject, or administrative subject acts or reassigns the route target.

In some implementations, the transfer criterion is not a single global threshold. Instead, the system stores, for each decision task, a task-class identifier and a regime identifier, and retrieves a task-class-specific threshold, a regime-specific threshold, or both. The transfer criterion may be satisfied when the degradation score exceeds a threshold selected according to the task class of the decision task, the current regime, or a combination thereof. By way of example, a release-review task may use a first threshold, an electronic-design-automation task may use a second threshold, and a research-workflow task may use a third threshold, and each such threshold may further vary across a normal regime, a high-load regime, an audit-enhanced regime, and an emergency-transfer regime.

An approval-conflict-adjustment engine may manage conflicts among multiple approval gates and allow restart only after the conflict is resolved.

A state-management engine may manage multiple states or regimes, including a normal regime, a high-load regime, an audit-enhanced regime, and an emergency-transfer regime.

An audit-log engine may store at least a task identifier, time, operator identifier, operation type, evidence references, before-state, after-state, before-routing destination, after-routing destination, reason code, and one or more preserved-intermediate-result identifiers.

### Example 1: Human-Agent and AI-Agent Collaboration

An artificial-intelligence agent may generate candidate proposals and attach evidence such as explanatory information, similar cases, test results, or validation results. A human agent may make a final approval decision, a deferment decision, or a reevaluation decision. If the human agent becomes unavailable or delayed, first-stage approval authority or reevaluation-request authority may be reassigned to a different human agent or a different artificial-intelligence agent, while final approval remains reserved to an audit or administrative agent.

### Example 2: Multiple AI Agents or Multiple Information Processing Systems

A first artificial-intelligence agent may generate a candidate, a second artificial-intelligence agent may perform a safety evaluation, and a third artificial-intelligence agent or an external system may perform an audit evaluation. When these outputs conflict, the arbitration engine may select an adopted candidate or defer the candidate. If a subject evaluator degrades, the system may redirect routing to a successor evaluator while preserving accepted intermediate results and unresolved subtasks.

### Example 3: Release Review

A candidate process may be a release request. Evidence may include test results, anomaly-detection results, vulnerability-evaluation results, model-evaluation reports, and review comments. Approval-state information may correspond to quality review, safety review, legal review, and operational review. If a particular review agent becomes degraded, the system may reassign only the relevant subset of approval authority.

### Example 4: Electronic Design Automation

A candidate process may be a design-change request, a constraint change, a verification-job submission, or a pre-tapeout approval. Evidence may include timing results, power results, area results, DRC/LVS results, simulation results, and review records. The system may preserve accepted intermediate analysis results and designate only unresolved portions for re-execution.

### Example 5: Research Workflow

A candidate process may be an experiment-execution decision, an analysis-condition change, a hypothesis deferment, or an additional-verification determination. Evidence may include dataset references, analysis logs, visualization results, review comments, and external evaluation results.

### Example 6: Log Compression and History Minimization

The system may store only a minimal but sufficient differential history, including task identifier, change type, before/after difference, evidence identifier, restart-condition identifier, and intermediate-result identifier, while maintaining detailed history externally by reference.

### Example 7: Integrity-Verified Restart

The system may verify a hash or signature of the inheritable state package before restart and may block restart if tampering, corruption, expiration, or an invalidation condition is detected.

### Example 8: Successor Selection and Notification

The system may pre-register multiple successor candidates, select a successor based on a successor-selection score, and notify a subject agent, successor agent, audit agent, or administrative agent upon authority transfer, routing change, restart initiation, reevaluation request, or stop determination.

### Claim-Support Notes

The disclosed engines and data structures may be implemented as instruction-executed modules on one or more processors using one or more memories. The inheritable state package, the authority-mapping table, the successor-resume package, preserved intermediate results, and audit logs may be stored in one or more machine-readable stores.

In some implementations, a transfer criterion is satisfied when a degradation score satisfies a threshold condition stored for a task class or regime corresponding to the decision task. In some implementations, the authority-mapping table stores a route target for each transferred request type. In some implementations, preserved intermediate results are individually verified and only unresolved subtasks associated with failed or missing verification are marked for re-execution.

### Additional Support Notes for Claim Differentiation

In some implementations, the disclosed transfer-and-resume architecture differs from a release-state-governance architecture because the disclosed transfer criterion depends on degradation of a current subject and causes transfer of less than all authority to a distinct successor subject together with preservation of verified intermediate results and resume of only unresolved subtasks. In some implementations, the disclosed transfer-and-resume architecture differs from a deferment-only architecture because deferment is used as a trigger for generating the inheritable state package rather than as a terminal control action. In some implementations, the disclosed transfer-and-resume architecture differs from a restoration-only architecture because the disclosed architecture updates the authority-mapping table to redirect at least one request type to a distinct successor subject before resume.

### Advantages

The disclosed techniques reduce interruption caused by departure or degradation of a responsible agent, improve reproducibility and auditability by coupling state information and authority information, and allow efficient successor-side resume from intermediate stages while avoiding unnecessary restart of already accepted portions.

1. A collaborative decision-processing system comprising:
one or more processors; and
one or more memories storing instructions that, when executed by the one or more processors, cause the system to:
receive, for a decision task collaboratively handled by multiple subjects, candidate-task data, evidence-reference data, an approval-state record, an authority-state record, and an identifier of a current subject;
determine whether the decision task is to be approved, deferred, or re-evaluated;
responsive to determining to defer the decision task, generate and store an inheritable state package for the decision task, the inheritable state package comprising:
(i) a task identifier,
(ii) a process-stage identifier,
(iii) an unresolved-item list,
(iv) one or more evidence-reference pointers,
(v) an approval-state bit field,
(vi) an authority-token set,
(vii) at least one resume condition, and
(viii) a checkpoint reference or a re-execution reference;
calculate, from at least two metrics selected from availability, response latency, error rate, backlog, confidence score, and audit-pass rate, a degradation score for the current subject;
determine that a transfer criterion is satisfied when the degradation score satisfies a threshold condition;
responsive to the transfer criterion being satisfied, update a machine-readable authority-mapping table by (a) assigning, for each transferred authority type, a route target that identifies a successor subject different from the current subject and (b) retaining at least one non-transferred authority type assigned to the current subject, an audit subject, or an administrative subject;
verify integrity of one or more preserved intermediate results associated with the checkpoint reference or the re-execution reference; and
resume, by the successor subject and based on the inheritable state package and the updated authority-mapping table, only unresolved subtasks for which the successor subject is identified as an authorized route target while preserving the verified intermediate results.

2. A computer-implemented method for collaborative decision processing, the method comprising:
receiving, for a decision task collaboratively handled by multiple subjects, candidate-task data, evidence-reference data, an approval-state record, an authority-state record, and an identifier of a current subject;
determining whether the decision task is to be approved, deferred, or re-evaluated;
responsive to determining to defer the decision task, generating and storing an inheritable state package for the decision task, the inheritable state package comprising:
(i) a task identifier,
(ii) a process-stage identifier,
(iii) an unresolved-item list,
(iv) one or more evidence-reference pointers,
(v) an approval-state bit field,
(vi) an authority-token set,
(vii) at least one resume condition, and
(viii) a checkpoint reference or a re-execution reference;
calculating, from at least two metrics selected from availability, response latency, error rate, backlog, confidence score, and audit-pass rate, a degradation score for the current subject;
determining that a transfer criterion is satisfied when the degradation score satisfies a threshold condition;
responsive to the transfer criterion being satisfied, updating a machine-readable authority-mapping table by (a) assigning, for each transferred authority type, a route target that identifies a successor subject different from the current subject and (b) retaining at least one non-transferred authority type assigned to the current subject, an audit subject, or an administrative subject;
verifying integrity of one or more preserved intermediate results associated with the checkpoint reference or the re-execution reference; and
resuming, by the successor subject and based on the inheritable state package and the updated authority-mapping table, only unresolved subtasks for which the successor subject is identified as an authorized route target while preserving the verified intermediate results.

3. The system of claim 1, wherein the confidence score is calculated from at least two metrics selected from approval-consistency rate, audit-pass rate, resume-success rate, and rule-conformance rate.

4. The system of claim 1, wherein the transfer criterion is determined according to a task-class-specific or regime-specific threshold stored for the decision task.

5. The system of claim 1, wherein the authority-mapping table includes fields for:
a task identifier,
an authority type,
a current-subject identifier,
a successor-subject identifier,
an activation condition,
an expiration condition, and
a route target.

6. The system of claim 1, wherein the successor subject is selected according to a successor-selection score calculated from at least two metrics selected from availability, processing capacity, task-fit score, and prior resume-success rate.

7. The system of claim 1, wherein the determination to defer or re-evaluate the decision task is made when an evidence-sufficiency score is below a threshold or when divergence among outputs of multiple decision engines exceeds a threshold.

8. The system of claim 1, wherein the approval-state bit field encodes states of multiple approval gates for the decision task.

9. The system of claim 1, wherein the authority-token set encodes at least two authorities selected from approval authority, re-evaluation-request authority, modification authority, execution authorization, stop authority, and audit-request authority.

10. The system of claim 1, further comprising generating a successor-resume package distinct from the inheritable state package, the successor-resume package identifying the successor subject, a transferred authority subset, an allowed operation scope, and an expiration time.

11. The system of claim 1, wherein verifying integrity comprises verifying a cryptographic hash value or a digital signature associated with the preserved intermediate results.

12. The system of claim 11, wherein, when a preserved intermediate result fails integrity verification, a corresponding subtask is marked for re-execution while a verified intermediate result is preserved for resume.

13. The system of claim 1, wherein, when outputs of multiple decision engines conflict, the system performs weighted arbitration using at least an evidence-sufficiency score, a confidence score, and the approval-state bit field.

14. The system of claim 1, wherein the updated authority-mapping table changes a route target for a transferred request type while retaining, for a non-transferred request type, a route target assigned to the current subject, the audit subject, or the administrative subject.

15. The system of claim 1, wherein the system records, in an audit log, at least a before-transfer authority state, an after-transfer authority state, a route change, and a reason code for the transfer.

16. The system of claim 1, wherein the inheritable state package includes an expiration time or an invalidation condition, and the system blocks resume of the decision task after expiration or invalidation until a re-approval or re-evaluation operation is performed.

17. The system of claim 1, wherein the transferred less-than-all authorities exclude a final-approval authority, and wherein the transfer comprises transferring first-stage approval authority or re-evaluation-request authority to the successor subject while the final-approval authority remains assigned to an audit subject or an administrative subject.
